(19) United States
(12) Patent Application Publication
(10) Pub. No.: US 2009/0039798 A1
(43) Pub. Date: Feb. 12, 2009

(54) Pulsed igniting device comprising a piezoelectric transformer for a high-pressure discharge lamp

(75) Inventor: Bernhard Siessegger, Munchen (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munchen (DE)

(21) Appl. No.: 11/918,480

(22) PCT Filed: Apr. 11, 2006
(86) PCT No.: PCT/DE2006/000637

§ 371 Date: Oct. 15, 2007

(30) Foreign Application Priority Data
Apr. 14, 2005 (EP) 05008228.8
Nov. 2, 2005 (DE) 10 2005 052 555.5

(51) Int. Cl. H05B 41/24

(52) U.S. Cl. 315/276

(57) ABSTRACT

A device for igniting the gas discharge in a high-pressure discharge lamp (La). The igniting device is embodied as a pulsed igniting device (C, FS, Tr1) while a piezoelectric transformer (PT) is provided for supplying the pulsed igniting device (C, FS, Tr1) with voltage.

The invention relates to an igniting device in accordance with the preamble of patent claim 1, and to a corresponding method.

### I. PRIOR ART

Such an igniting device is disclosed, for example, in WO 98/18297. This document describes a circuit arrangement for operating a high pressure discharge lamp comprising a voltage transformer, embodied as an inverter, a load circuit fed by the inverter and provided with connections for a high pressure discharge lamp and with an inductor for limiting the lamp current, and a pulsed igniting device for igniting the gas discharge in the high pressure discharge lamp. The circuit arrangement also has a transformer for separating the inverter metallically from the load circuit and the pulsed igniting device. The pulsed igniting device comprises a spark gap, an ignition capacitor that is charged to the breakdown voltage of the spark gap in order to ignite the gas discharge in the high pressure discharge lamp, and an ignition transformer via whose primary winding the ignition capacitor is discharged after the breakdown of the spark gap, and by whose secondary winding high voltage pulses are generated for igniting the gas discharge in the high pressure discharge lamp. The voltage supply to this pulsed igniting device is generated by means of the inverter and of the above-named transformer serving the metallic separation.

EP-A 1 496 725 discloses an igniting device for a high pressure discharge lamp that is equipped with a piezoelectric transformer. In order to ignite the gas discharge in the high pressure discharge lamp, the primary side of the piezoelectric transformer is fed with an alternating voltage whose frequency corresponds to a resonant frequency of the piezoelectric transformer. On the secondary side of the piezoelectric transformer, this generates a high voltage that is fed to an auxiliary ignition electrode of the high pressure discharge lamp in order to ignite the gas discharge in the high pressure discharge lamp.

### II. SUMMARY OF THE INVENTION

It is an object of the invention to provide an improved pulsed igniting device for a high pressure discharge lamp that is suitable for operating the high pressure discharge lamp with a high frequency lamp current, that is to say with a frequency greater than 0.1 MHz, or at a low supply voltage of the pulsed igniting device.

This object is achieved according to the invention by the features of patent claim 1. Particularly advantageous designs of the invention are described in the dependent patent claims.

The inventive igniting device is embodied as a pulsed igniting device, and a piezoelectric transformer is provided for supplying it with voltage. By using a piezoelectric transformer for supplying the pulsed igniting device with voltage, it is possible to make use in the pulsed igniting device of an ignition transformer having a substantially lower voltage transformation ratio, since it is already possible to implement high voltage transformation ratios by means of the piezoelectric transformer, and therefore the supply voltage ready on the secondary side of the piezoelectric transformer for the pulsed igniting device is substantially amplified with reference to the input voltage present on its primary side, and it is now necessary for the pulsed ignition transformer to generate only the difference between the ignition voltage of the high pressure discharge lamp and supply voltage of the pulsed igniting device, in order to be able to ignite the gas discharge in the high pressure discharge lamp.

It is particularly advantageous to use the piezoelectric transformer for supplying a pulsed igniting device with voltage when the high pressure discharge lamp is operated with a high frequency lamp current, that is to say with a frequency of greater than 0.1 MHz, because it is thereby possible to reduce the turns ratio of secondary to primary winding and the secondary inductance of the ignition transformer of the pulsed igniting device, and thus the voltage drop at the secondary winding of the ignition transformer flowed through by the high frequency lamp current. On the other hand, the efficiency of the entire system during lamp operation after ignition of the gas discharge has taken place would suffer from the high inductance of the secondary winding of the ignition transformer, because even after the gas discharge has been ignited a high voltage drop would still occur at the secondary winding of the ignition transformer flowed through by the high frequency lamp current. Consequently, only relatively low turns ratios of the ignition transformer of less than 20 are permissible, since otherwise the number of turns per unit length of the primary winding becomes very small, for example, equal to 1, and this results in a poor magnetic coupling of primary and secondary windings of the ignition transformer, a high current through the primary winding during ignition with high loading of the components of the pulsed igniting device, and only an inefficient generation of high voltage. If, nevertheless, the aim is to generate high ignition voltages of approximately 20 kV, it is necessary to use in the pulsed igniting device a switching means having a higher blocking voltage than the customary 350 V to 800V. Consequently the requirement arises of supplying the pulsed igniting device with a higher voltage than in the case of a lamp operation in accordance with the prior art. This is particularly advantageously achieved with the inventive igniting device and the inventive operating device.

The ignition transformer advantageously has a design in which the magnetic flux largely runs in the magnetic material, for example ferrite or iron, of the transformer core, in order to ensure good electromagnetic compatibility and minimization of the losses outside the ignition transformer that are caused by the magnetic field. The ignition transformer therefore preferably has a virtually closed core, for example a toroidal core or a cup-type core with air gap.

It is particularly advantageous, moreover, to use the piezoelectric transformer to supply a pulsed igniting device with voltage when only a relatively low supply voltage, for example, of less than 500 V, is available for the pulsed igniting device, since this is generated, for example, from the network voltage of a motor vehicle.

It is advantageous to connect a voltage doubling circuit or a cascade circuit downstream of the voltage output of the piezo-electric transformer, in order further to increase the supply voltage for the pulsed igniting device.

In accordance with the preferred exemplary embodiments, the inventive pulsed igniting device comprises a switching means, for example, a voltage-dependent switching means, with an operating point voltage, a charge storage means that can be charged to the operating point voltage of the voltage-dependent switching means, and an ignition transformer for generating the ignition voltage required for igniting the gas discharge of the high pressure discharge lamp. The components of the igniting device are preferably arranged in the interior of the lamp base of the high pressure discharge lamp. In addition, the piezoelectric transformer is preferably also accommodated in the lamp base of the high pressure discharge lamp.

### III. DESCRIPTION OF THE PREFERRED EXEMPLARY EMBODIMENTS

The invention is explained below in more detail with the aid of a number of preferred exemplary embodiments. In the drawing,

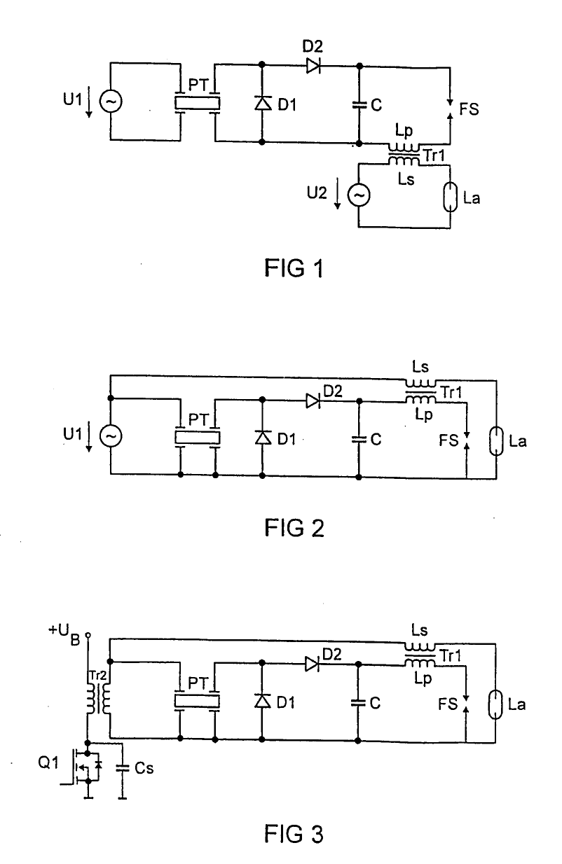

FIG. 1 shows a sketched circuit diagram of the igniting device and of the operating device of the high pressure discharge lamp in accordance with the first exemplary embodiment of the invention,

FIG. 2 shows a sketched circuit diagram of the igniting device and of the operating device of the high pressure discharge lamp in accordance with the second exemplary embodiment of the invention,

FIG. 3 shows a sketched circuit diagram of the igniting device and of the operating device of the high pressure discharge lamp in accordance with the third exemplary embodiment of the invention,

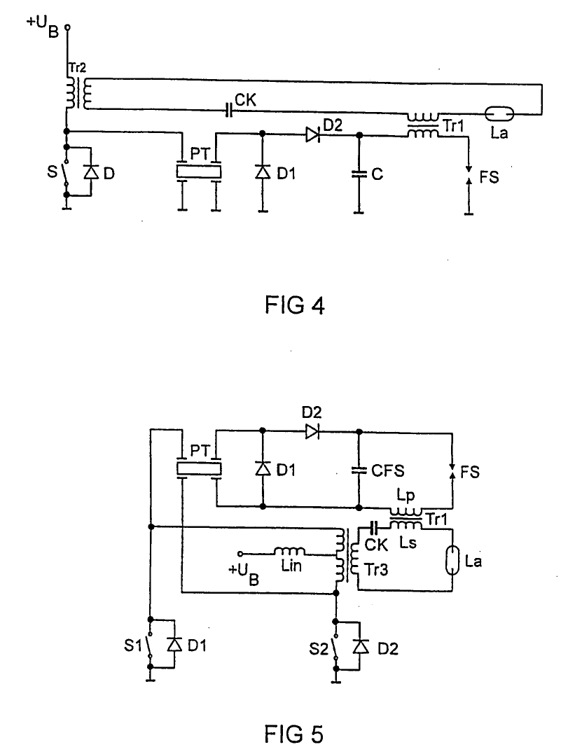

FIG. 4 shows a sketched circuit diagram of the igniting device and of the operating device of the high pressure discharge lamp in accordance with the fourth exemplary embodiment of the invention,

FIG. 5 shows a sketched circuit diagram of the igniting device and of the operating device of the high pressure discharge lamp in accordance with the fifth exemplary embodiment of the invention,

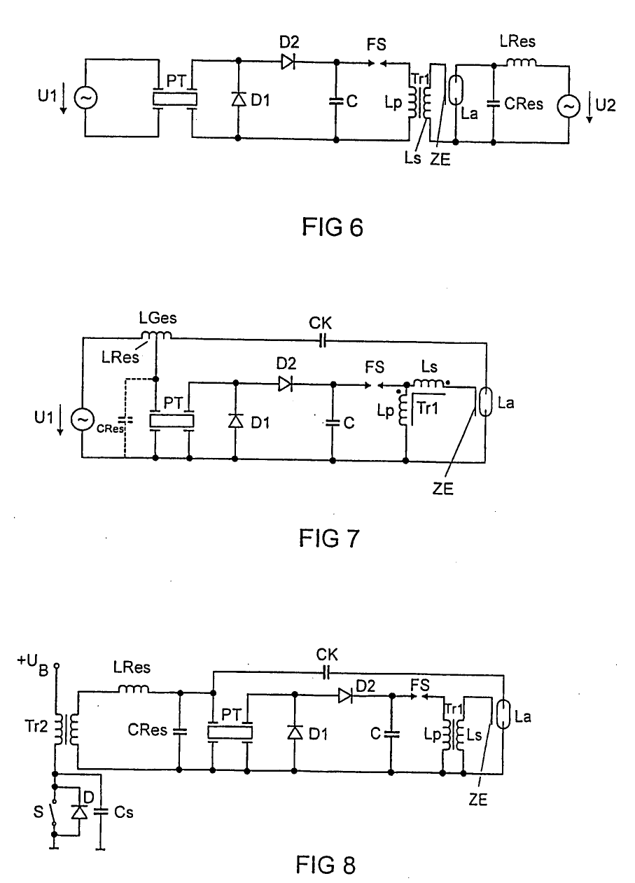

FIG. 6 shows a sketched circuit diagram of the igniting device and of the operating device of the high pressure discharge lamp in accordance with the sixth exemplary embodiment of the invention,

FIG. 7 shows a sketched circuit diagram of the igniting device and of the operating device of the high pressure discharge lamp in accordance with the seventh exemplary embodiment of the invention,

FIG. 8 shows a sketched circuit diagram of the igniting device and of the operating device of the high pressure discharge lamp in accordance with the eighth exemplary embodiment of the invention,

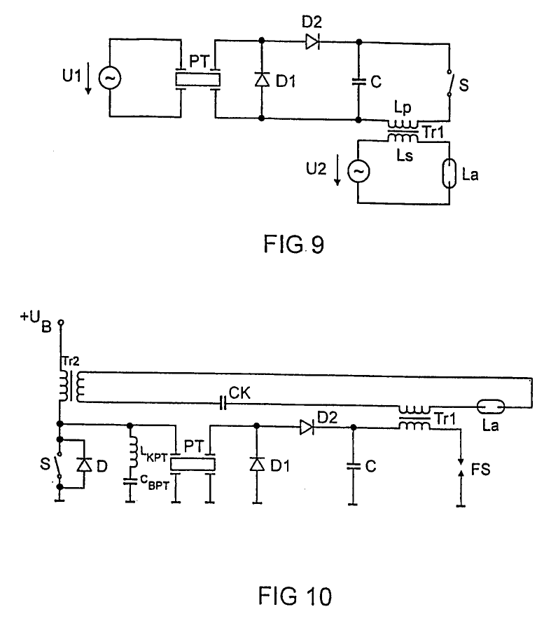

FIG. 9 shows a sketched circuit diagram of the igniting device and of the operating device of the high pressure discharge lamp in accordance with the ninth exemplary embodiment of the invention,

FIG. 10 shows a sketched circuit diagram of the igniting device and of the operating device of the high pressure discharge lamp in accordance with the fourth exemplary embodiment of the invention with partial compensation of the input capacitance of the piezoelectric transformer.

FIG. 1 illustrates schematically the sketched circuit diagram of a pulsed igniting device and of an operating device for a high pressure discharge lamp in accordance with the first exemplary embodiment of the invention.

The pulsed igniting device comprises an ignition capacitor C, a spark gap FS, or another, arbitrary voltage-dependent switching means, for example a DIAC or a combination of a DIAC and a thyristor, which is activated or deactivated upon reaching a specific operating point voltage, and an ignition transformer Tr1 with primary winding Lp and secondary winding Ls. The series circuit of spark gap FS and primary winding Lp is connected in parallel with the ignition capacitor C. The pulsed igniting device is supplied with voltage by an AC voltage source U1, a piezoelectric transformer PT and a voltage doubling circuit that is formed by the diodes D1, D2 and the ignition capacitor C. Once the gas discharge has been ignited in the high pressure discharge lamp La, the lamp La is operated by means of the AC voltage source U2, which generates a lamp current flowing via the secondary winding Ls of the ignition transformer Tr1. In order to ignite the gas discharge in the high pressure discharge lamp La, the piezoelectric transformer PT is excited on its primary side by means of the AC voltage source U1 at an AC voltage frequency that is near a resonant frequency of the piezoelectric transformer PT. As a result, there is generated on its secondary side a high voltage that is rectified by means of the diodes D1, D2 of the voltage doubling circuit such that the rectified, doubled output peak voltage of the piezoelectric transformer PT is present at the ignition capacitor C. When the piezoelectric transformer PT is excited at one of its resonant frequencies by means of the AC voltage source U1, there is available at the ignition capacitor C a voltage that is sufficient for breaking down the spark gap FS such that the ignition capacitor C is discharged in pulses at an ignition repetition frequency of approximately 100 Hz via the spark gap FS and the primary winding Lp of the ignition transformer Tr1. This induces in the secondary winding Ls of the ignition transformer Tr1 high voltage pulses that ignite the gas discharge in the high pressure discharge lamp La. After the gas discharge has been ignited in the high pressure discharge lamp La, the AC voltage source U1 is either deactivated, or the frequency of its AC voltage is changed such that it exhibits a distance from the resonant frequencies of the piezoelectric transformer that is sufficient for avoiding excitation of the piezoelectric transformer PT, and/or for preventing the ignition capacitor C from being charged to the breakdown voltage of the spark gap FS.

Illustrated schematically in FIG. 9 is the sketched circuit diagram of a pulsed igniting device and of an operating device for a high pressure discharge lamp in accordance with the ninth exemplary embodiment of the invention. It differs from the first exemplary embodiment only in that instead of the voltage-dependent switching means FS use is made of any other desired switch S, for example a thyristor, an IGBT, a MOSFET or an externally triggerable spark gap with the aid of a trigger electrode. The switch S is provided with a sequence of drive pulses that corresponds to the ignition repetition frequency of the pulsed igniting device. It is to be ensured in this case that the capacitor C is charged to a sufficiently high voltage before arrival of a corresponding drive pulse.

FIG. 2 illustrates schematically the sketched circuit diagram of a pulsed igniting device and of an operating device for a high pressure discharge lamp in accordance with the second exemplary embodiment of the invention. It differs from the first exemplary embodiment only in that a single, common AC voltage source U1 is provided for supplying the piezoelectric transformer PT with voltage with the aid of a downstream pulsed igniting device and the high pressure discharge lamp La such that the voltage source U2 is dispensed with. First and second exemplary embodiments correspond in all other details. Consequently, the same reference symbols have been used in FIGS. 1 and 2 for identical components. The AC voltage source U1 is preferably a voltage transformer U1 that generates a high frequency AC voltage for igniting and operating the high pressure discharge lamp La from the network voltage of the motor vehicle. In all the exemplary embodiments the high pressure discharge lamp La is preferably a metal halide high pressure discharge lamp with an electric power consumption of approximately 35 W that is provided as a light source in a vehicle headlamp. In order to ignite the high pressure discharge lamp La, the voltage transformer or the voltage source U1 generates an AC voltage whose frequency is close to a resonant frequency of the piezoelectric transformer PT, so as to excite the piezoelectric transformer PT. The AC voltage generated on the secondary side of the piezoelectric transformer PT is rectified and doubled by means of the diodes D1, D2 such that the ignition capacitor C is charged to the rectified, doubled output voltage of the piezoelectric transformer PT, which is greater than the breakdown voltage of the spark gap FS. Consequently, the ignition capacitor C is discharged via the spark gap FS and the primary winding Lp of the ignition transformer Tr1. There are thus induced in the secondary winding Ls of the ignition transformer Tr1 high voltage pulses that lead to ignition of the gas discharge in the high pressure discharge lamp La. After the gas discharge has been ignited in the high pressure discharge lamp La, the frequency of the AC voltage generated by the voltage transformer or the voltage source U1 is varied such that it has a sufficient distance from the resonant frequencies of the piezoelectric transformer PT in order not to excite the latter, or to avoid charging the ignition capacitor C to the breakdown voltage of the spark gap FS. For example, the AC voltage source U1 can be implemented as a DC-DC converter (for example a boost converter) with downstream inverter (for example full bridge inverter). During the ignition phase, the switching frequency of the full bridge is selected to be near a resonant frequency of the piezoelectric transformer PT at approximately 100 kHz and is reduced to approximately 400 Hz after ignition has taken place. Alternatively, during the ignition phase of the high pressure discharge lamp La the switching frequency of the full bridge can also be, for example, only a fifth of the resonant frequency of the piezoelectric transformer PT, in order to excite the piezoelectric transformer PT with a harmonic component included in the signal of the voltage source U1, for example the 5th harmonic. If, however, a high frequency lamp operation is intended, it is possible, for example, to use a piezoelectric transformer PT with a resonant frequency of, for example, 400 kHz which is excited with an AC voltage of approximately 400 kHz in order to ignite the gas discharge in the high pressure discharge lamp La. After termination of the ignition phase, the frequency of the AC voltage is raised to 2 MHz, for example, for the further lamp operation, in order not to excite the piezoelectric transformer PT further and to operate the high pressure lamp La above its acoustic resonances. The lamp power is regulated, for example, by varying the frequency of the AC voltage, since this correspondingly varies the frequency-dependent reactance of the secondary winding Ls flowed through by the lamp current. Similar to an inductor, the secondary winding Ls serves to stabilize the discharge of the high pressure discharge lamp La.

If the frequency of the AC voltage generated by the voltage source U1 is always above the resonant frequency of the piezoelectric transformer PT, it is advantageous to use amplitude modulation to excite the piezoelectric transformer PT, the modulation frequency being equal to the resonant frequency of the piezoelectric transformer PT. For example, in the case of a piezoelectric transformer PT with a resonant frequency of 100 kHz, use is made of an amplitude-modulated AC voltage with a carrier frequency of 4 MHz and a modulation frequency of 100 kHz in order to excite the piezoelectric transformer PT during the ignition phase of the high pressure discharge lamp La. After termination of the ignition phase, either the modulation is switched off, or the modulation frequency and/or the modulation depth, is varied such that the voltage generated by the piezoelectric transformer PT no longer leads to breakdown of the spark gap FS. After termination of the ignition phase, amplitude modulation of the AC voltage generated by the voltage transformer U1 is maintained, for example, in order thereby to achieve a straightening of the discharge arc, which is curved because of the convection in the discharge plasma, of the high pressure discharge lamp La by using the amplitude modulation to excite acoustic resonances in the discharge plasma.

FIG. 3 illustrates schematically the sketched circuit diagram of a pulsed igniting device and of an operating device for a high pressure discharge lamp in accordance with the third exemplary embodiment of the invention. This exemplary embodiment differs from the second exemplary embodiment only in that the AC voltage source U1 is designed as a single transistor voltage transformer by means of which the voltages required for igniting and operating the high pressure discharge lamp La are generated from the network voltage U_{B} of the motor vehicle. The single transistor voltage transformer has a clocked switching means, preferably a field effect transistor Q1 (for example a power MOSFET) whose switching clock determines the frequency of the AC voltage generated by the voltage transformer U1, and a capacitor Cs, connected in parallel with the switching path of the switching means Q1, as well as a transformer Tr2 whose primary winding is connected in series with the parallel circuit consisting of the switching means Q1 and the capacitor Cs. The secondary winding of the transformer Tr2 is connected in parallel with the input of the piezoelectric transformer PT and with the series circuit consisting of secondary winding Ls of the ignition transformer Tr1 and discharge path of the high pressure discharge lamp La. During the ignition phase, the voltage at the secondary winding of the transformer Tr2 serves to supply voltage to, or to excite, the piezoelectric transformer PT, and after the gas discharge has been ignited it serves to supply voltage to the high pressure discharge lamp La. As already explained above, the frequency of the AC voltage generated by the voltage transformer, and therefore also the switching frequency of the switching means Q1 differs during the ignition phase and after termination of the ignition phase.

FIG. 4 illustrates schematically the sketched circuit diagram of a pulsed igniting device and of an operating device for a high pressure discharge lamp in accordance with the fourth exemplary embodiment of the invention. The fourth exemplary embodiment differs from the third exemplary embodiment only in that in accordance with the fourth exemplary embodiment (FIG. 4) the capacitor Cs connected in parallel with the switching means Q1 (FIG. 3) is replaced by the input capacitance of the piezoelectric transformer PT, and the secondary winding of the transformer Tr2 is connected in parallel with the series circuit of capacitor CK, secondary winding Ls of the ignition transformer Tr1 and discharge path of the high pressure discharge lamp La. The capacitor CK is optional and serves for partially compensating the inductance of the secondary winding Ls during lamp operation after termination of the ignition phase. The switching means S and the diode D connected in parallel with the switching means S correspond to the field effect transistor Q1 and its body diode in FIG. 3. Just like the capacitor Cs in exemplary embodiment three, the input capacitance of the piezoelectric transformer PT ensures that the switching means operated with zero voltage switching. If the input capacitance of the piezoelectric transformer PT should be too low for operating the voltage transformer, in the circuit arrangement in accordance with FIG. 4 it is possible to connect a further capacitor in parallel with the input of the piezoelectric transformer PT and the switching means S. If the input capacitance of the piezoelectric transformer PT should be too large for operating the voltage transformer, it is possible to connect a capacitor in series with the input of the piezoelectric transformer PT in the circuit arrangement in accordance with FIG. 4, which capacitor, together with the input capacitance of the piezoelectric transformer PT, forms a capacitive voltage divider. Alternately, given an excessively high input capacitance of the piezoelectric transformer PT it is possible in accordance with FIG. 10 to connect an inductor L_{KPT} in parallel with the input of the piezoelectric transformer so as to achieve a partial compensation of its input capacitance. In order in this case to prevent short circuiting of the input voltage source U_{B}, via the primary winding of the transformer Tr2 and the inductor added for partial compensation, it is necessary to connect a blocking capacitor C_{BPT} of sufficient size in series with this inductor, and to connect this series circuit in parallel with the input of the piezoelectric transformer. The blocking capacitor C_{BPT} prevents a direct current through the inductor L_{KPT}, but in contrast leaves the AC behavior of the described arrangement largely uninfluenced. In FIGS. 3 and 4, the same reference symbols have been used for identical components of the two exemplary embodiments. The mode of operation of the fourth exemplary embodiment corresponds to the second and third exemplary embodiments.

FIG. 5 illustrates schematically the sketched circuit diagram of a pulsed igniting device and of an operating device for a high pressure discharge lamp in accordance with the fifth exemplary embodiment of the invention. The fifth exemplary embodiment differs from the second or fourth exemplary embodiment only in that instead of the single transistor voltage transformer a current-fed push-pull converter is used as AC voltage source or voltage transformer U1. The feeding of current during operation of the lamp after the gas discharge has been ignited in the high pressure discharge lamp is ensured by the input inductor Lin through which an approximately constant current then flows. The current-fed push-pull converter (FIG. 5) consists of two alternately operating switching means S1, S2 that are preferably designed as field effect transistors (power MOSFET) with integrated body diode D1, D2, and of the inductor Lin, the input capacitance of the piezoelectric transformer PT and the transformer Tr3. The transformer Tr3 has two primary windings which are connected such that the current can flow from the positive pole of the battery U_{B} via the first primary winding to the frame terminal when the switch S1 is closed, and can flow via the second primary winding of the transformer Tr3 to the frame terminal when the second switch S2 is closed. The switching clock of the switching means S1 and S2 determines the frequency of the AC voltage that is available at the input of the piezoelectric transformer PT, and the frequency of the AC voltage that is generated at the secondary winding of the transformer Tr3 for the purpose of supplying voltage to the load circuit connected thereto. Similar to the fourth exemplary embodiment, the input capacitance of the piezoelectric transformer PT ensures that the two switches S1 and S2 are operated with zero voltage switching. The load circuit consists of the series circuit of capacitor Ck, secondary winding Ls of the ignition transformer Tr1 and the discharge path of the high pressure discharge lamp La. The voltage doubling circuit, consisting of the diodes D1, D2 and the ignition capacitor CFS, is connected to the voltage output of the piezoelectric transformer PT such that the rectified doubled output peak voltage of the piezoelectric transformer PT is present at the ignition capacitor CFS. The igniting device, fed from the piezoelectric transformer PT and the voltage doubling circuit, of the high pressure discharge lamp La consists of the ignition capacitor CFS, the spark gap FS and the ignition transformer Tr1 with its primary winding Lp and its secondary winding Ls. During the ignition phase of the high pressure discharge lamp La, the switching frequency of the switching means S1, S2 is set such that the piezoelectric transformer PT is excited with an AC voltage whose frequency corresponds to one of its resonant frequencies. Consequently, the ignition capacitor CFS is charged to the breakdown voltage of the spark gap FS, and then is discharged via the primary winding Lp of the ignition transformer Tr1 and the spark gap FS. Consequently, there are induced in the secondary winding Ls of the ignition transformer Tr1 high voltage pulses that lead to the ignition of the gas discharge in the high pressure discharge lamp La. After termination of the ignition phase, the switching frequency of the switching means S1, S2 is varied such that the piezoelectric transformer PT is no longer excited, and the voltage drop across the ignition capacitor CFS is no longer sufficient to break down the spark gap FS. The high pressure discharge lamp La is supplied with energy via the secondary winding of the transformer Tr3. The secondary winding Ls, flowed through by the lamp current, of the ignition transformer Tr1 acts in this case as inductor for limiting the lamp current. Particularly in the case of a high frequency lamp current, the optional capacitor CK serves for partially compensating the inductance of the secondary winding Ls of the ignition transformer Tr1.

If the input capacitance of the piezoelectric transformer PT is intended to be too low for operating the push-pull converter S1, S2, Tr3, it is possible to connect a capacitor with appropriately selected capacitance in parallel with the input of the piezoelectric transformer PT. If, by contrast, the input capacitance of the piezoelectric transformer PT is intended to be too high for the operation of the push-pull converter S1, S2, Tr3, a capacitor with appropriately selected capacitance can be connected in series with the input of the piezoelectric transformer PT. Alternatively, given an excessively high input capacitance of the piezoelectric transformer PT it is possible by connecting an inductor in parallel with the input of the piezoelectric transformer to achieve a partial compensation of the input capacitance of the latter. By contrast with the design in accordance with exemplary embodiment four no blocking capacitor is required here.

FIG. 6 illustrates schematically the sketched circuit diagram of a pulsed igniting device and of an operating device for a high pressure discharge lamp in accordance with the sixth exemplary embodiment of the invention. It differs from the first exemplary embodiment in that the high pressure discharge lamp La has an auxiliary ignition electrode ZE to which, during the ignition phase of the high pressure discharge lamp La, the pulsed igniting device applies high voltage pulses for igniting the gas discharge in the lamp La. The pulsed igniting device in accordance with FIG. 6 comprises an ignition capacitor C, a spark gap Fs, or another arbitrary voltage-dependent switching means that is activated or deactivated when a specific operating point voltage is reached, and an ignition transformer Tr1 with primary winding Lp and secondary winding Ls. The series circuit of spark gap FS and primary winding Lp is connected in parallel with the ignition capacitor C. Serving for supplying voltage to the pulsed igniting device are an AC voltage source U1, a piezoelectric transformer PT and a voltage doubling circuit that is formed by the diodes D1, D2 and the ignition capacitor C. After the gas discharge has been ignited in the high pressure discharge lamp La, the lamp La is operated by means of the AC voltage source U2 and the series resonant circuit LRes, CRes, which generate an alternating current via the discharge path of the high pressure discharge lamp La. In order to ignite the gas discharge in the high pressure discharge lamp La, the frequency of the AC voltage source U2 is selected such that there is generated at the series resonant circuit LRes, CRes, a sufficiently high voltage that is present between the two main electrodes of the high pressure discharge lamp La and enables or supports ignition of the discharge via the auxiliary ignition electrode ZE. Furthermore, by means of the AC voltage source U1 the piezoelectric transformer PT is excited on its primary side with an AC voltage frequency that is close to a resonant frequency of the piezoelectric transformer PT. Consequently, there is generated on its secondary side a high voltage that is rectified by means of the diodes D1, D2 of the voltage doubling circuit such that the rectified, doubled output peak voltage of the piezoelectric transformer PT is present at the ignition capacitor C. When the piezoelectric transformer PT is excited with one of its resonant frequencies by means of the AC voltage source U1, there is available at the ignition capacitor C a voltage that suffices to break down the spark gap FS such that the ignition capacitor C is discharged in pulses via the spark gap FS and the primary winding Lp of the ignition transformer Tr1. As a result, there are induced in the secondary winding Ls of the ignition transformer Tr1 high voltage pulses that are fed to the auxiliary ignition electrode ZE and are coupled capacitively by means of the auxiliary ignition electrode ZE into the discharge medium of the high pressure discharge lamp La in order to ignite the gas discharge in the high pressure discharge lamp La. After the gas discharge has been ignited in the high pressure discharge lamp La, the AC voltage source U1 is either deactivated, or the frequency of its AC voltage is changed such that it exhibits a distance from the resonant frequencies of the piezoelectric transformer that is sufficient for avoiding excitation of the piezoelectric transformer PT, and/or for preventing the ignition capacitor C from being charged to the breakdown voltage of the spark gap FS. After termination of the ignition phase, the lamp is operated by means of the AC voltage source U2 and the series resonant circuit LRes, CRes.

FIG. 7 illustrates schematically the sketched circuit diagram of a pulsed igniting device and of an operating device for a high pressure discharge lamp in accordance with the seventh exemplary embodiment of the invention. It differs from the sixth exemplary embodiment in that the second AC voltage source U2 is dispensed with, and the high pressure discharge lamp La is ignited and operated with only one AC voltage source U1. The capacitor CK is optional and serves for partially compensating the inductance LGes during operation of the lamp after termination of the ignition phase. The inductance LGes denotes the total inductance of the autotransformer, LRes denoting only the inductance of the first winding section that is connected to the voltage source U1 and the input of the piezoelectric transformer PT. Moreover, by contrast with the design according to FIG. 6, the ignition transformer Tr1 of the pulsed igniting device in accordance with FIG. 7 is designed as autotransformer. In order to ignite the high pressure discharge lamp La, the voltage transformer or the voltage source U1 generates an AC voltage whose frequency is close to a resonant frequency of the piezoelectric transformer PT, in order to excite the piezoelectric transformer PT. A harmonic component included in the signal of the voltage source U1 can also be used for the excitation. The series resonant circuit LRes, CRes is dimensioned such that it generates a sufficiently high voltage that is present between the two main electrodes of the high pressure discharge lamp La and enables or supports an ignition of the discharge via the auxiliary ignition electrode ZE. If appropriate, the function of the capacitor CRes can be taken over by the input capacitance of the piezoelectric transformer PT. Consequently, the component CRes is illustrated with dashes in FIG. 7. The AC voltage generated on the secondary side of the piezoelectric transformer PT is rectified and doubled by means of the diodes D1, D2 such that the ignition capacitor C is charged to the rectified, doubled output voltage of the piezoelectric transformer PT, which is greater than the breakdown voltage of the spark gap FS. Consequently, the ignition capacitor C is discharged via the spark gap FS and the primary winding Lp of the ignition transformer Tr1. Thus, there are induced in the secondary winding Ls of the ignition transformer Tr1 high voltage pulses that are applied to the auxiliary ignition electrode ZE of the high pressure discharge lamp La in order to ignite the gas discharge in the high pressure discharge lamp La. After the gas discharge has been ignited in the high pressure discharge lamp La, the frequency of the AC voltage generated by the voltage transformer or the voltage source U1 is varied such that it has a sufficient distance from the resonant frequencies of the piezoelectric transformer PT in order not to excite the latter, or to avoid charging the ignition capacitor C to the breakdown voltage of the spark gap FS. After the ignition phase, the high pressure discharge lamp La is operated on the AC voltage source U1 by means of the series resonant circuit LRes, CRes. The electric power consumption of the high pressure discharge lamp La is regulated by varying the frequency of the AC voltage U1. In particular, immediately after the ignition phase, in the so-called starting phase, the high pressure discharge lamp La can be operated at a multiple of its nominal power by means of the series resonant circuit consisting of LGes and CK, in order to achieve a rapid evaporation of the discharge medium, for example the metal halides. The inductance LRes furthermore limits the lamp current and thereby effects the stabilization of the discharge.

FIG. 8 illustrates schematically the sketched circuit diagram of a pulsed igniting device and of an operating device for a high pressure discharge lamp in accordance with the eighth exemplary embodiment of the invention. It differs from the seventh exemplary embodiment in that in the case of the eighth exemplary embodiment the AC voltage source U1 is designed as a single transistor voltage transformer, and the ignition transformer Tr1 is not designed as autotransformer. The AC voltage to be supplied to the piezoelectric transformer PT and the high pressure discharge lamp La is generated with the aid of the controllable switching means S, the diode D connected in parallel therewith, the capacitor Cs connected in parallel with the switching means S, and the transformer Tr2 from the network voltage U_{B} of the motor vehicle. The switching means S and the diode D are preferably designed as field effect transistors with integrated body diode, as illustrated in FIG. 3. The switching clock of the switching means S determines the frequency of the AC voltage generated by the voltage transformer. The secondary winding of the transformer Tr2 supplies the series resonant circuit LRes, CRes with energy. The input or the primary side of the piezoelectric transformer PT, and the discharge path of the high pressure discharge lamp La are respectively connected in parallel with the resonance capacitor CRes. In order to ignite the gas discharge in the high pressure discharge lamp La, the switching frequency of the switching means S, and thus the frequency of the AC voltage generated by the single transistor voltage transformer is tuned to a resonant frequency of the piezoelectric transformer PT. Moreover, the series resonant circuit formed from LRes, CRes and the input capacitance of the piezoelectric transformer PT is excited such that a peak voltage of approximately 800 V is produced during ignition between the two main electrodes of the high pressure discharge lamp La. The output voltage of the piezoelectric transformer PT is rectified and doubled by means of a voltage doubling circuit D1, D2, C such that there is present at the ignition capacitor C of the pulsed igniting device C, FS, Tr1 the rectified doubled output voltage of the piezoelectric transformer PT which suffices to break down the spark gap FS upon excitation of the piezoelectric transformer PT with its resonant frequency such that the ignition capacitor C is discharged via the spark gap FS and the primary winding Lp of the ignition transformer Tr1. Consequently, there are induced in the secondary winding Ls of the ignition transformer Tr1 high voltage pulses that are applied to the auxiliary ignition electrode ZE of the high pressure discharge lamp La in order to ignite the gas discharge in the high pressure discharge lamp La. After the gas discharge has been ignited, the switching frequency of the switching means S is changed such that there is no longer any excitation of the piezoelectric transformer PT, and no further breakdown of the spark gap FS. The voltage provided by the secondary winding of the transformer Tr2 then serves for supplying the series resonant circuit LRes, CRes and the high pressure discharge lamp La. As already described above in conjunction with the seventh exemplary embodiment, the power consumption of the high pressure discharge lamp La is regulated by varying the switching frequency of the switching means S, and thus by varying the AC voltage frequency. In stationary operation, the high pressure discharge lamp La has a running voltage in the range from approximately 40 V to 90 V.

1. An igniting device for igniting the gas discharge in a high pressure discharge lamp (La), the igniting device being embodied as a pulsed igniting device (C, FS, Tr1), characterized in that one piezoelectric transformer (PT) is provided for the voltage supply of the pulsed igniting device (C, FS, Tr1).

2. The igniting device as claimed in claim 1, in which the pulsed igniting device has a switching means (FS), a charge storage means (C), and an ignition transformer (Tr1) for generating the ignition voltage required for igniting the gas discharge of the high pressure discharge lamp (La).

3. The igniting device as claimed in claim 1, in which a voltage doubling circuit (D1, D2, C) is connected downstream of the voltage output of the piezoelectric transformer (PT).

4. The igniting device as claimed in claim 2, in which the switching means (FS) is a voltage-dependent switching means.

5. The igniting device as claimed in claim 2, in which the switching means (FS) has an operating point voltage of greater than 800 V.

6. The igniting device as claimed in claim 2, in which the igniting device is fed with a supply voltage of less than 500 V.

7. The igniting device as claimed in claim 2, in which the lamp is ignited by means of an auxiliary ignition electrode (ZE).

8. Igniting device as claimed in claim 1, in which the input capacitance of the piezoelectric transformer (PT) is part of a resonant circuit that is excited during ignition in order to generate a sufficiently high voltage between the main electrodes of the lamp.

9. The igniting device as claimed in claim 8, in which a capacitor (CK) is arranged in series with the inductor (LGes) of the resonant circuit, which ensures a sufficiently high voltage between the main electrodes of the lamp during ignition, and serves for a partial compensation of the inductance (LGes) after the ignition.

10. The igniting device as claimed in claim 8, in which components of the igniting device (C, FS, Tr1) or/and the piezoelectric transformer (PT) are accommodated in the lamp base of the high pressure discharge lamp (La).

11. Operating device for a high pressure discharge lamp (La) having a pulsed igniting device (C, FS, Tr1) and a piezoelectric transformer (PT) for the voltage supply of the pulsed igniting device (C, FS, Tr1).

12. The operating device as claimed in claim 11, which supplies the high pressure discharge lamp with a lamp current whose frequency is higher than 0.1 MHz.

13. The operating device as claimed in claim 11, in which the input capacitance of the piezoelectric transformer (PT) constitutes a functional component of the voltage transformer that supplies the lamp (La) with energy.

14. The operating device as claimed in claim 13, in which the input capacitance of the piezoelectric transformer (PT) serves to relieve the switching load of one or more of the semiconductor switches used.

15. A method for operating a high pressure discharge lamp, an igniting device embodied as a pulsed igniting device (C, FS, Tr1) serving to ignite the gas discharge in the high pressure discharge lamp (La), characterized in that the pulsed igniting device (C, FS, Tr1) is supplied with voltage with the aid of a piezoelectric transformer (PT).

16. The method as claimed in claim 15, the pulsed igniting device (C, FS, Tr1) being switched off by providing at the voltage output of the piezoelectric transformer (PT) a supply voltage for the pulsed igniting device (C, FS, Tr1) that is not sufficient for switching over a voltage-dependent switching means (FS) of the pulsed igniting device (C, FS, Tr1).

17. The method as claimed in claim 15, the pulsed igniting device being switched off by varying the frequency spectrum of the voltage exciting the piezoelectric transformer (PT) such that there is generated at the voltage output of the piezoelectric transformer (PT) a supply voltage for the pulsed igniting device (C, FS, Tr1) that is not sufficient for switching over a voltage-dependent switching means (FS) of the pulsed igniting device (C, FS, Tr1).

18. The method as claimed in claim 15, in which the piezoelectric transformer (PT) is excited by an amplitude-modulated signal.

19. The method as claimed in claim 15, in which the piezoelectric transformer is excited by a harmonic component of one of its resonant frequencies that is included in the frequency spectrum of the voltage present at the voltage input of the piezoelectric transformer (PT).

20. The igniting device as claimed in claim 2, in which a voltage doubling circuit (D1, D2, C) is connected downstream of the voltage output of the piezoelectric transformer (PT).
